(19) United States
(12) Patent Application Publication
(10) Pub. No.: US 2009/0064340 A1
(43) Pub. Date: Mar. 5, 2009

(54) Apparatus and Method to Prevent the Illegal Reading of Smart Cards

(75) Inventors: Tai-Shui Ho, Shanghai City (CN); Jacky Hung, Shanghai City (CN); Yong-Feng Gu, Shanghai City (CN)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: INVENTEC APPLIANCES CORP., Taipei Hsien (TW)

(21) Appl. No.: 12/202,613

(22) Filed: Sep. 2, 2008

(30) Foreign Application Priority Data
Aug. 30, 2007 (TW) 96132293

(51) Int. Cl. G06F 21/00

(52) U.S. Cl. 726/26

(57) ABSTRACT

An apparatus to prevent smart cards from being read illegally is provided, wherein the apparatus is installed in a smart card reader comprises a CPU and a socket with a plurality of fingers, and the apparatus comprises: an electric circuits board (ECB), an inner circuit and a supplementary circuit. The ECB is disposed to cover the fingers and wired with an inner circuit electrically connected to a power supply. The supplementary circuit has an input terminal and an output terminal, wherein the input terminal is electrically connected to the power supply through the inner circuit of the ECB, and the output terminal is electrically connected to the CPU of the smart card reader; when the inner circuit is interrupted, an alarm signal is outputted by the supplementary circuit to the CPU to terminate the reading of the smart card by the smart card reader.

### RELATED APPLICATIONS

This application claims priority to Taiwan Application Serial Number 96132293, filed Aug. 30, 2007, which is herein incorporated by reference.

### FIELD OF THE INVENTION

The present invention relates to an apparatus and methods for information security, and more particularly relates to an apparatus installed in a smart card reader to protect data from being illegally read and the methods for applying the apparatus.

### BACKGROUND OF THE INVENTION

Plastic money, such as credit cards and cash cards are wildly applied in the present financial system. However, even though technology has advanced, traditional magnetic strips have no protection against being copied and fraudulent cards are therefore on the increase. Currently, cards having embedded integrated circuits are considered to have better information security than the traditional magnetic stripe cards due to the difficulties of duplication that have been applied to prevent credit cards and cash cards from being illegally read and copied.

Credit cards or cash cards with integrated circuits (ICs) embedded therein are also called integrated circuit cards (ICCs), chip cards, memory cards, microprocessor cards or smart cards (hereinafter referred to as “smart cards”). Smart cards not only provide a debit payment function identical to what has been provided by the traditional magnetic stripe cards, but also provide an integrated function involving various banking services, such as money-withdrawal, accounts transferring, credit consumption or bonus points collection. Hence, the smart cards provide better information security and operating convenience than the traditional magnetic stripe cards. Smart cards will therefore gradually take the place of the traditional magnetic stripe cards, and become the major device for credit payment and banking services.

However, smart cards still have drawbacks that are e.g. the trading information being stolen, and a risk of the card being read illegally. For example, since each sale point or store requires a smart card reader to read the trading information saved in the ICs of the smart card and to feed the dealers information back to the banking system, the criminals can steal the trading information from and defraud the bank through the smart card reader rather than directly duplicate the smart card.

In some practical examples, each of the smart cards has a plurality of exposed pins used to electrically connect with a socket of the smart card reader to exchange trading information. Some criminals may drill the covers of the smart card reader to insert digital probes, and thus, when the smart cards are inserted into the smart card reader, the trading information saved in the smart card will be stolen via the probes. Even though there are some security designs to remedy this drawback caused by the pin-socket mechanism, the risk of being read illegally still cannot be eliminated.

Therefore, it is desirable to provide an advanced apparatus installed with the pins-socket mechanism to protect the trading information from being read illegally.

### SUMMARY OF THE INVENTION

One aspect of the present invention is to provide an apparatus installed in a smart card reader to protect smart cards inserted into a smart card reader from being read illegally, wherein the smart card reader comprises a central processing unit (CPU) and a socket with a plurality of fingers, the plurality of fingers are for engaging with a smart card inserted into the socket. In the embodiments of the present invention, the apparatus comprises an electric circuit board (ECB) and a supplementary circuit. The ECB is disposed to cover the fingers and wired with an inner circuit electrically connected to a power supply. The supplementary circuit has an input terminal and an output terminal, wherein the input terminal is electrically connected to the power supply through the inner circuit of the ECB, and the output terminal is electrically connected to the CPU of the smart card reader. When the inner circuit is stopped, the supplementary circuit transmits an alarm signal to the CPU, and the reading of the smart card by the smart card reader is then terminated in accordance with the alarm signal.

Another aspect of the present invention is to provide a method to protect smart cards inserted into a smart card reader from being read illegally, wherein the method comprises steps as follows: First a smart card reader with a CPU and a socket with a plurality of fingers is provided. An ECB is then disposed to cover the fingers of the socket, wherein the ECB comprises an inner circuit electrically connected to a power supply. Subsequently a supplementary circuit with an input terminal and an output terminal is provided, wherein the input terminal is electrically connected to the power supply through the inner circuit of the ECB, and the output terminal is electrically connected to the CPU of the smart card reader. When the inner circuit is interrupted, the supplementary circuit transmits an alarm signal to the CPU, and the reading of the smart card by the smart card reader is then terminated in accordance with the alarm signal to prevent fingers from undesired detection.

In accordance with the embodiments of present invention, a feature of the present invention is to install an ECB wired with an inner circuit in a socket of a traditional smart card reader to cover a plurality of fingers in the socket. The inner circuit is electrically connected to a power supply, and a supplementary circuit is used to detect whether the inner circuit is interrupted, wherein an input terminal of the supplementary circuit is electrically connected to the power supply via the inner circuit, and an output terminal of the supplementary circuit is electrically connected to a CPU of a smart card reader. When the inner circuit is interrupted by an external force or the current flowing through the supplementary circuit is interrupted, the supplemental circuit will send an alarm signal to the CPU to terminate the reading of the smart card by the smart card reader and trigger an alarm, thereby preventing the smart card from being read illegally.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a smart card reader for reading smart cards installed in a Point-of-Sales (POS) retailing system.

FIG. 2 illustrates a circuit diagram of the supplementary circuit in accordance with some preferred embodiments of the present invention.

FIG. 3 illustrates a block flow diagram of a method to protect smart cards from being read illegally in accordance with preferred embodiments of the present invention.

### DETAILED DESCRIPTION OF THE PREFERRED EMBODIMENT

The foregoing aspects and many of the attendant advantages of this invention will become more readily appreciated, as the same becomes better understood by reference to the following embodiments. As is understood by a person skilled in the art, the following preferred embodiments of the present invention are illustrative of the present invention rather than limiting of the present invention, the scope of the present invention should be accorded the broadest interpretation of the appended claims.

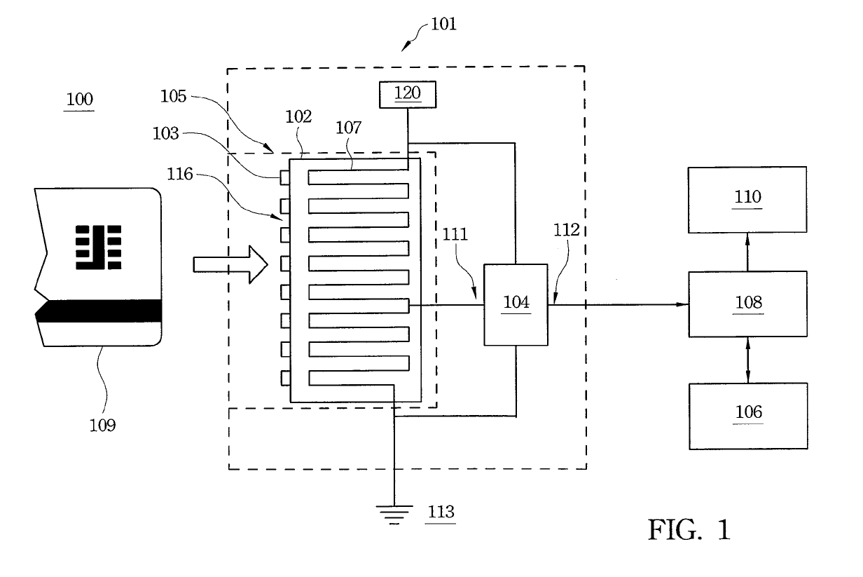

FIG. 1 illustrates a smart card reader 100 for reading smart cards installed in a Point-of-Sales (POS) retail system. The smart card reader 100 has an apparatus 101 for preventing the smart card from being read illegally, a memory module 106, a CPU 108, a buzzer 110 and a socket 105 with a plurality of fingers 103. The fingers 103 are for engaging with a smart card inserted into the socket 105.

The apparatus for preventing a smart card from being read illegally 101 comprises an ECB 102 and a supplementary circuit 104. The ECB 102 is disposed in a recess 116 formed on the socket 105 to cover the fingers 103, or the ECB 102 is disposed over a recess 116 formed on the socket 105 to cover the fingers 103. In the embodiments of the present invention, the preferred ECB 102 is a printed circuit board (PCB) fully wired with at least one inner circuit 107 covering thereon, wherein one terminal of the inner circuit 107 is electrically connected to a power supply 120; and another terminal of the inner circuit 107 is electrically connected to a grounding loop 113. In this embodiment, the inner circuit 107 is a signal wire with many bends and turns meandering on the PCB to form a wire mesh; but in another embodiment the inner circuit 107 can be wired in other ways. In the embodiments of the present invention, no matter how the inner circuit 107 is wired, the ECB 102 may be fully covered with wires, and may be no blank space of the ECB 102 remains.

The supplementary circuit 104 has an input terminal 111 and an output terminal 112, wherein the input terminal 111 is electrically connected to the power supply 120 through the inner circuit 107 of the ECB 102, and the output terminal 112 is electrically connected to the CPU 108 of the smart card reader 100. In the present embodiment, the output terminal 112 is electrically connected to a general purpose I/O (GPIO) (not shown) of the CPU 108.

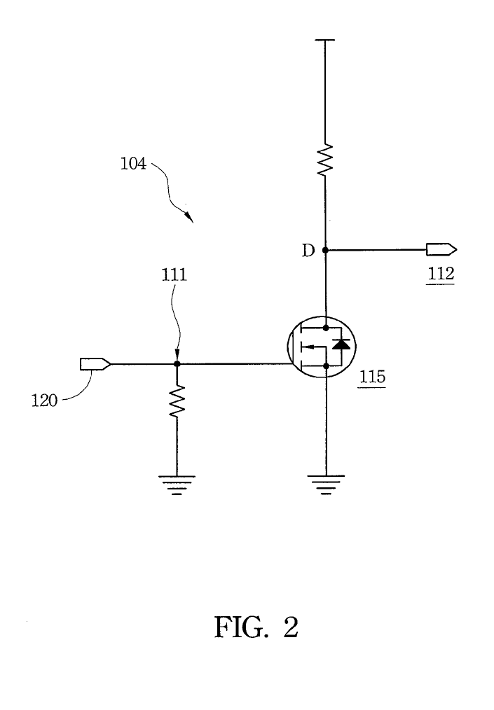

FIG. 2 illustrates a circuit diagram of the supplementary circuit 104 in accordance with some preferred embodiments of the present invention, wherein the supplementary circuit 104 comprises at least one Metal-Oxide-Semiconductor Field Effect Transistor (MOSFET) 115 serving as a switch to allow or interrupt the electric current supplied by the power supply 120 flowing through the supplementary circuit 104. When the inner circuit 107 is interrupted, the current flowing through the supplementary circuit 104 may be interrupted.

For example, in some embodiments of the present invention, when the criminals interrupt the ECB 102 to steal the trading information saved in the smart card 109. The inner circuit 107 may be interrupted due to the ECB 102 being interrupted physically. Alternatively, the criminals may insert detecting probes (not shown) to steal the trading information transmitted by the fingers 103. While being inserted, the probes interrupt the inner circuit 107 first and then the fingers 103, to interrupt the current from the power supply 120 and passing through the inner circuit 107.

After the inner circuit 107 is interrupted, an alarm signal due to a potential difference (from high/low potential changing to low/high potential) occurs on the MOSFET 115 and is directed to the CPU 108 of the smart card reader 100 via the output terminal 112 of the supplementary circuit 104. The CPU 108 terminates the reading of the smart card 109 by cutting the connections to the memory 106 off, and turns the buzzer 110 on in accordance with the alarm signal so as to prevent the smart card from being read illegally.

Since the fingers 103 of the socket 105 are covered by the ECB 102, and the inner circuit 107 on the ECB 102 is integrated with the smart card reader 100 through the supplementary circuit 104, the criminals should interrupt the ECB 102 prior to stealing the trading information saved in the smart card 109. Thus the inner circuit 107 of the ECB 102 would be interrupted or the current flowing through the supplementary circuit 104 would be interrupted, and the alarm signal outputted by the supplementary circuit 104 is directed to the CPU 108 of the smart card reader 100. Subsequently, the CPU 108 terminates the reading of the smart card 109 by cutting the connections to the memory 106 off, and turns an alarm (such as a buzzer 110, an indicating lamp or a monitor) on. It must be appreciated that FIG. 2 is just an illustrative embodiment of the present invention; the person skilled in the art can further provide various modifications and similar arrangements included within the spirit of the present invention.

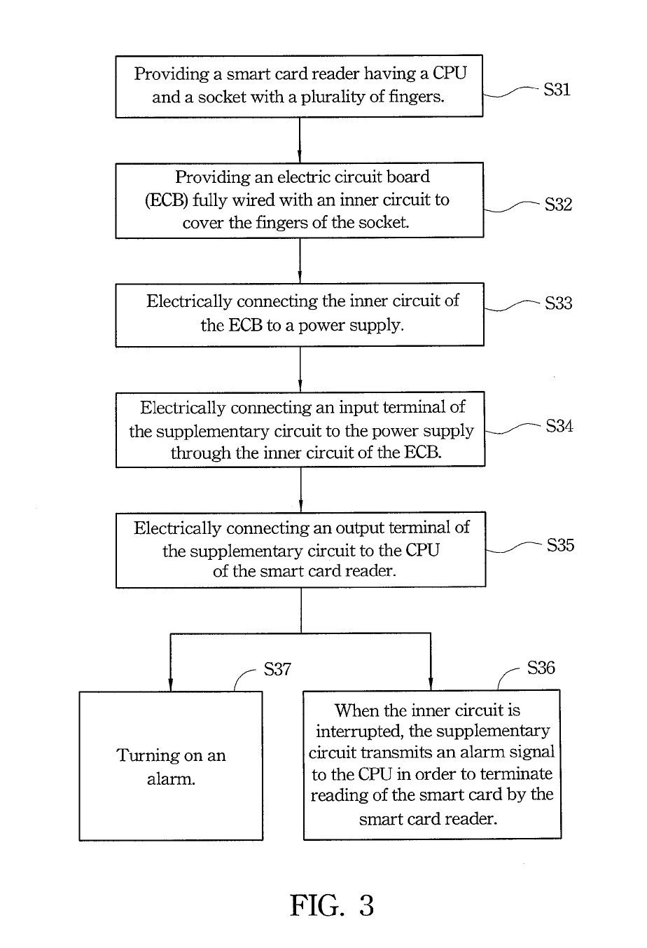

FIG. 3 illustrates a block flow diagram of a method to protect smart cards from being read illegally in accordance with preferred embodiments of the present invention. In some embodiments of the present invention the method is applied in a Point-of-Sales (POS) retailing system shown in FIG. 1 to protect smart cards 109 inserted in the smart card reader 100 from being read illegally, wherein the method comprises the following steps:

In the first block S31, a smart card reader 100 is provided. As shown in FIG. 1, the smart card reader 100 has a CPU 108 and a socket 105 with a plurality of fingers 103. Subsequently an ECB 102 preferably fully wired with an inner circuit 107 is provided to cover the fingers 103 of the socket 105 (as shown in the block S32). Referring to block S33, the inner circuit 107 of the ECB 102 is then electrically connected to a power supply 120. Subsequently a supplementary circuit 104 with an input terminal 111 and an output terminal 112 is provided, wherein the input terminal 111 of the supplementary circuit 104 is electrically connected to the power supply 120 through the inner circuit 107 of the ECB 102 (referring to the block S34), and the output terminal 112 is electrically connected to the CPU 108 of the smart card reader 100 (referring to the block S35). When the inner circuit 107 is interrupted, the supplementary circuit 104 transmits an alarm signal to the CPU 108 in order to terminate reading of the smart card by the smart card reader (referring to the block S36) and to turn on an alarm (referring to the block S37) so as to prevent the fingers 103 from undesired detection.

In accordance with the foregoing preferred embodiments of present invention, an ECB wired with an inner circuit is disposed to cover a plurality of fingers of a socket of a smart card reader to prevent the fingers from undesired detection. The inner circuit is electrically connected with a GPIO of the CPU of the smart card reader to integrate the ECB with the motherboard of the smart card reader. This design could restrict the criminals who want to steal trading information by inserting detecting probes into the socket without breaking through the ECB. When the ECB or the inner circuit is interrupted, an alarm signal can be transmitted to the CPU to terminate the reading of the smart card by the smart card reader.

The advantage of the present invention is applying an apparatus with simple structure, low cost and easy assembly (such as a ECB with a simple wire pattern) to integrate with an existing device of a traditional smart card reader (such as the general purpose I/O of the CPU installed in the smart card reader) to protect the smart cards inserted therein from being illegally read to accomplish the object of the present invention, such that the long existing but unsolved security problem in the field can be solved by the embodiments of the present invention.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. An apparatus to prevent smart cards from being read illegally, wherein the apparatus is installed in a smart card reader which comprises a CPU and a socket with a plurality of fingers, the plurality of fingers are for engaging with a smart card inserted into the socket, and the apparatus comprises:
an electric circuit board (ECB) disposed to cover the fingers and wired with an inner circuit electrically connected to a power supply; and
a supplementary circuit with an input terminal and an output terminal, wherein the input terminal is electrically connected to the power supply through the inner circuit of the ECB, and the output terminal is electrically connected to a central processing unit (CPU) of the smart card reader;
when the inner circuit is interrupted, an alarm signal is outputted by the supplementary circuit to the CPU to terminate the reading of the smart card by the smart card reader.

2. The apparatus in accordance with claim 1, wherein the alarm signal is a potential difference from a low potential changing to a high potential transmitted from the supplementary circuit to the CPU.

3. The apparatus in accordance with claim 1, wherein the alarm signal is a potential difference from a high potential changing to a low potential transmitted from the supplementary circuit to the CPU.

4. The apparatus in accordance with claim 1, wherein the output terminal of the supplementary circuit is electrically connected to a general purpose I/O (GPIO) of the CPU.

5. The apparatus in accordance with claim 1, wherein the ECB is disposed in a recess formed on the socket to cover the fingers.

6. The apparatus in accordance with claim 1, wherein the ECB is disposed over a recess formed on the socket to cover the fingers.

7. The apparatus in accordance with claim 1 or 2, wherein the ECB is fully wired with the inner circuit covering thereon.

8. The apparatus in accordance with claim 1, wherein the supplementary circuit comprises at least one Metal-Oxide-Semiconductor Field Effect Transistor (MOSFET) serving as a switch.

9. The apparatus in accordance with claim 1, wherein the CPU terminates the reading process proceeded by the smart card reader and turns on an alarm in accordance with the alarm signal.

10. The apparatus in accordance with claim 8, wherein the alarm is a buzzer, an indicating lamp or a monitor.

11. The apparatus in accordance with claim 1, wherein when the inner circuit is interrupted due to the ECB being interrupted physically, the alarm signal is outputted by the supplementary circuit to the CPU to terminate the reading of the smart card by the smart card reader.

12. The apparatus in accordance with claim 1, wherein when the inner circuit is interrupted to interrupt the current from the power supply and passing through the inner circuit, the alarm signal is outputted by the supplementary circuit to the CPU to terminate the reading of the smart card by the smart card reader.

13. A method to protect a smart card inserted into a smart card reader from being read illegally, comprising:
providing a smart card reader comprising a CPU and a socket with a plurality of fingers, wherein the plurality of fingers are for engaging with a smart card inserted into the socket;
disposing an ECB to cover the fingers of the socket, wherein the ECB comprises an inner circuit electrically connected to a power supply;
providing a supplementary circuit with an input terminal and an output terminal, wherein the input terminal is electrically connected to the power supply through the inner circuit of the ECB, and the output terminal is electrically connected to the CPU of the smart card reader; and
when the inner circuit is interrupted, transmitting an alarm signal from the supplementary circuit to the CPU in order to terminate the reading of the smart card by the smart card reader.

14. The method in accordance with claim 13, wherein the alarm signal is a potential difference from a low potential changing to a high potential transmitted from the supplementary circuit to the CPU.

15. The method in accordance with claim 13, wherein the alarm signal is a potential difference from a high potential changing to a low potential transmitted from the supplementary circuit to the CPU.

16. The method in accordance with claim 13, wherein the output terminal of the supplementary circuit is electrically connected to a GPIO of the CPU.

17. The method in accordance with claim 13, wherein the ECB is disposed in a recess formed on the socket to cover the fingers.

18. The method in accordance with claim 13, wherein the ECB is disposed over a recess formed on the socket to cover the fingers.

19. The method in accordance with claim 13, wherein the ECB is fully wired with the inner circuit covering thereon.

20. The method in accordance with claim 13, further comprising:
terminating reading of the smart card by the smart card reader in accordance with the alarm signal; and
turning on an alarm.
